(19) United States
(12) Patent Application Publication
(10) Pub. No.: US 2004/0148178 A1
(43) Pub. Date: Jul. 29, 2004

(54) Service management system

(76) Inventor: Marshall D. Brain II, Raleigh, NC (US)

Correspondence Address: JINAN GLASGOW, P O BOX 28539, RALEIGH, NC, 276118539

(21) Appl. No.: 10/350,980

(22) Filed: Jan. 24, 2003

(51) Int. Cl. G06F 17/60

(52) U.S. Cl. 705/1

(57) ABSTRACT

An expert system for managing a service operation, including an automated management system for managing a service operation, including software running on at least one computer and communications devices for allowing the computer to communicate with human and machine sensors and effectors, for providing automated task management and input/outputs.

### BACKGROUND OF THE INVENTION

(1) Field of the Invention

The present invention relates generally to management software and, more particularly, to an expert management system for retail service establishments.

(2) Description of the Prior Art

Simplification of tasks and work positions via semi-automation of work processes at retail service operations, e.g. fast food retail food and beverage establishments, have allowed these establishments to reduce the skill required to perform most tasks, thereby reducing the variability of the product or service delivered to the retail customer. Reducing the skill level requirement allows these establishments to employ low skill personnel at most workstations. However, because there are no constraints on the person performing these tasks, they can forget to perform tasks, go off-task, or perform tasks poorly if unsupervised. Additionally, the workflow may change, requiring the tasks and/or task order to change. Also, because there are multiple tasks to perform, these tasks are not necessarily performed in the best order to maximize customer satisfaction. To reduce the variability associated with these workflow problems, these establishments have managerial personnel to give instructions, resolve problems, prioritize tasks, organize people, and keep personnel on task. These managers are also subject to the same types of problems as low-skill manual labor employees, that is, variable managerial skill levels. Therefore, institutions with proper workflow procedures and manual labor personnel can have inadequate customer service due to inadequate management. Additionally, experienced managers represent a significant asset to an establishment. They frequently are responsible for employee hiring/firing, inventory management, employee scheduling, building maintenance, accounting/payroll, employee discipline/rewards, worker time breaks, legal compliance, etc. Thus, if an experienced manager leaves a particular establishment, the loss can represent a serious problem to the owners in terms of reduced operating efficiency and customer service. This managerial experience is valuable to business owners and potential buyers. Thus, a need exists to reduce the variability in management at retail services operations. A further need exists that the managerial experience acquired during operation of the business be retained at the establishment.

Specification

Definitions

Process—A series of operations or tasks performed in the making or treatment of a product or service.

Task—A function to be performed.

### SUMMARY OF THE INVENTION

The present invention is directed to an automated management system for managing a service operation, including software running on at least one computer and communications devices for allowing the computer to communicate with human and machine sensors and effectors, for providing automated task management and input/outputs.

The present invention is further directed to a method for using the automated management system.

Thus, the present invention provides an automated management system and method for managing a service operation, for various applications, in particular but not limited to, fast food and retail business operations and/or functions.

It is one aspect of the present invention to provide an automated management system for managing a service operation, including software running on at least one computer and communications devices for allowing the computer to communicate with human and machine sensors and effectors, wherein the software includes process control programs and logistics programs for managing at least one service function; and the communications devices include at least one human and at least one automated information input device and at least one information output device connected to the at least one computer.

It is another aspect of the present invention to provide a method for using an automated management system for managing a service operation, the system including software running on at least one computer and communications devices for allowing the computer to communicate with human and machine sensors and effectors, wherein the software includes process control programs and logistics programs for managing at least one service function; and the communications devices include at least one human and at least one automated information input device and at least one information output device connected to the at least one computer, the method including the steps of receiving workflow information from input provided via the communication devices, monitoring the workflow processes with the software, determining when a process needs executing, sending executable process tasks to task list, prioritizing task list, instructing employees to execute tasks via the communication devices.

These and other aspects of the present invention will become apparent to those skilled in the art after a reading of the following description of the preferred embodiment when considered with the drawings.

### BRIEF DESCRIPTION OF THE DRAWINGS

FIG. 1 is a flow diagram showing steps for using the system according to the present invention.

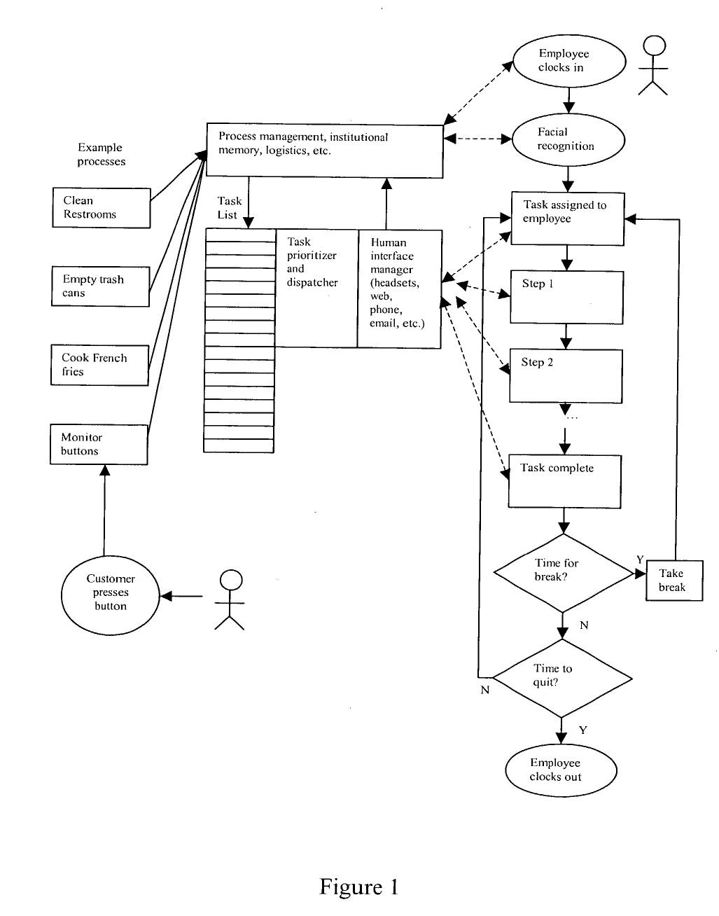

FIG. 2 is a diagram showing the components of the system according to the present invention and their interconnections.

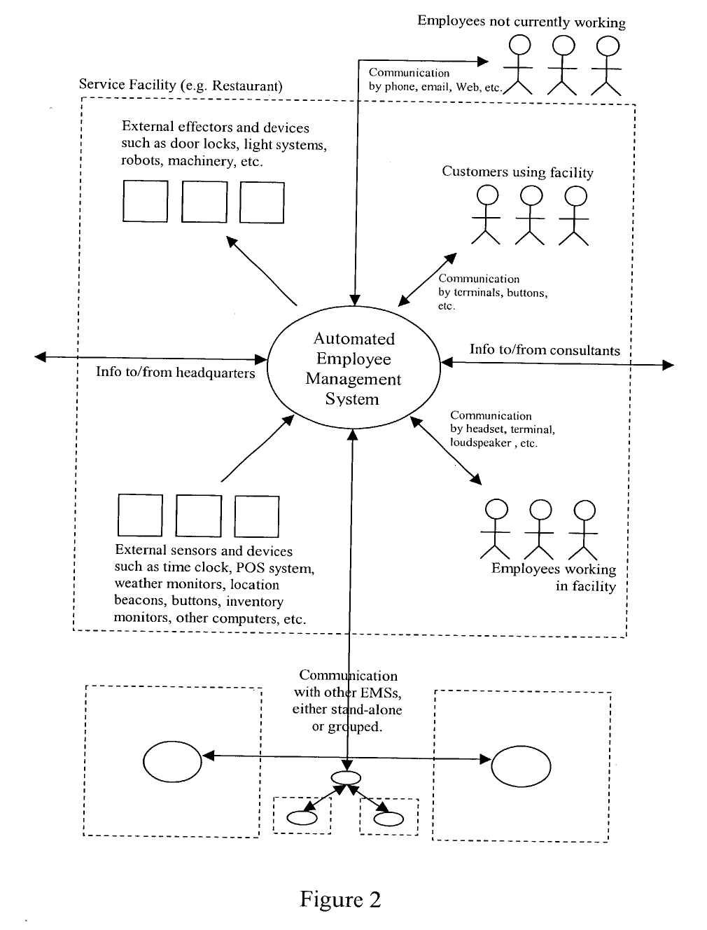

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

Referring now to the drawings in general, the illustrations are for the purpose of describing a preferred embodiment of the invention and are not intended to limit the invention thereto. One embodiment of the present invention provides an automated store management system for retail service operations or functions. The automated store management system receives information from sensors and employees, processes the information, and provides employees with workflow and task instructions. Thus, the automated manager system employs human beings as sensors and/or decision makers for select, pre-determined functions and/or tasks. A variety of tasks can be performed by the system, including, but not limited to, hiring/firing of employees, inventory management and control, employee scheduling, building maintenance scheduling, accounting and payroll, employee performance tracking and management, such as performance review, discipline and rewards, legal compliance, such as worker time breaks. Other functions performed can include: Accident/Injury Tracking, Applicant Flow, Applicant Tracking, Attendance and Time Tracking, Corporate Property Tracking, Job Advertisement, Salary Survey, Performance Review Tracking with History, Contract/Temporary Employee and Volunteer Tracking, and the like.

Generally, the system performs local managerial functions required to run a retail service operation or some function of the operation. The system consists of communications devices with which to gather and disseminate information and software running on at least one computer to analyze the information and determine workflow priorities.

The software can be running on a single computer or a multiplicity of computers. Additionally, multiple systems can be interconnected to provide for information exchange between establishments. The software consists of workflow process control programs with task control subprograms, logistics programs, and institutional memory.

The workflow is divided into processes composed of tasks. The system monitors these processes and their associated tasks. When a process requires executing, the software determines the tasks to be performed, then assigns the tasks to a Tasks List. Pending tasks on the Tasks List are then evaluated by a Task List program, which prioritizes the tasks and assigns an employee to a task. The system then instructs the employee to perform the task at the appropriate time. The system can also warn employee that s/he will need to perform a certain task shortly; thus, the employee can prepare him/herself mentally to perform the task when the computer instructs that the task now needs to be performed. Thus, the system performs process and task monitoring and issues commands for task execution.

In addition to human employees, the system can also manage automated machines, such as robots. For example, a machine that automatically fries potatoes can be in communication with the system and be instructed to fry a determined number of potatoes for delivery at a specific time. Thus, the system and communicate and control machine sensors and effectors.

The system can also perform quality control functions. The system can send a second employee to assess the task performance of a first employee assigned to a task. The second employee then reports to the system if the task was performed adequately.

Logistics as used herein is the aspect of operations that deals with the procurement, distribution, maintenance, and replacement of materiel and personnel. Logistics functions performed by the system include supplies inventory monitoring and ordering. The system tracks supply use and orders replenishment when use falls below a specific level. Additionally, the system can determine a supply's rate of consumption and order replenishment if projected use would cause a shortage based on the standard reorder level. Thus, the system would reduce the occurrence of supply outage.

Another logistical function performed by the system is staffing. The system predicts demand for functions at a future data and determines if staffing is adequate to perform the functions. If not, the system requests additional staff for the future date. For example, the system can communicate the future staff need to a personnel recruiter. Conversely, if the system notes too many employees for the workload, the system can terminate the employment of selected employees. The system also schedules employee attendance such that the establishment is adequately staffed while minimizing employee hours and overtime. In case of a temporary need for extra employees, the system can contact employee to request additional attendance or the system can contact a temporary staffing agency. Thus, because the system can anticipate the establishment's worker requirements, the system can ask for reinforcements prior to actually needing them and can send workers home when no longer needed.

Because the system can anticipate the establishment's worker requirements, the system is capable of asking for reinforcements prior to actually needing them and can send workers home when no longer needed.

The system also retains institutional, or establishment, memory. This memory is information specific to the particular establishment. The system receives information about the establishment, stores the information, process the information to look for patterns, and then stores the pattern information. This process simulates the way in which a manager gains experience about the management of a particular store. For example, through monitoring, the system has observed that on the first Saturday morning of each month a large amount of persons visit the establishment and order large coffee beverages. Upon discerning this pattern, the system would instruct the employees to start brewing larger than normal amounts of coffee on these days to prevent delays. Another example would be if a major sporting event occurred, for example, a giant stock car race, during which business was increased. After noting such a large variation from the mean outside of normal variation, for example more than 1.5 standard deviations from the mean, the system would interrogate an employee as to the motive for the variation, then determine if the event was a recurring event, and if so, amend the establishment work plan to compensate for the event in the future. These institutional memory and pattern information are valuable because they are retained by the establishment and will not be lost as human manager experience is when the manager leaves or is otherwise no longer working at the establishment.

In addition to managing routine processes, the system is capable of performing other managerial functions, such as performing non-repetitive management tasks, managing system errors or failures, and increasing overall efficiency. These functions are enhanced or facilitated by communication between multiple systems, which generates synergy between multiple systems.

Connection of multiple systems such that information can be shared between systems provides advantages both to the establishment and to the employees. For example, a supersystem including connection of multiple systems according to the present invention can share information about employees as employees move to new establishments. The employee's new system can then manage the employee as s/he was managed by the previous system, thus benefiting both the system and the employee. The new system does not have to “re-learn” the work characteristics of the employee. Sharing information thus develops a collective managerial experience that can be drawn upon by individual systems.

Also, experimental management practices can be tested rapidly and disseminated rapidly via the system according to the present invention when proven successful. The system can also implement managerial techniques more rapidly than ones that may appear counterintuitive to a human manager. For example, the system may increase overall establishment efficiency by reducing individual task efficiency in selected instances. The system of the present invention optimizes overall productivity and customer service by increasing employee satisfaction by having employees perform tasks in a manner that increases employee satisfaction but does not necessarily increase specific task efficiency.

In the cases where the establishment system can talk to other different business-type systems, the establishment system can request functions be performed by the other businesses. For example, the establishment system can ask another system for a bid on a job, e.g. repaving a parking lot, so that it can accumulate three or four bids and then pick the lowest cost supplier to do the job. This “extra-establishment” communication greatly enhances the abilities of the system.

The execution of non-repetitive tasks can frequently distinguish between good and poor managers and thus between profitability. These non-repetitive tasks inject variability into the process. The substitution of a human manager with an automated system that can draw on other systems to execute non-repetitive tasks should, in general, reduce variability at an establishment. Moreover, these non-repetitive tasks generate information that good managers store and retrieve when necessary at future dates. This information represents “experience” and the present invention captures, stores and analyzes this experience for reference when needed. Thus, the present invention retains establishment “experience” over time.

Although it is possible to create extremely reliable systems with today's technology using systems such as uninterruptible power supplies and redundant disks, it is important to recognize that a complete system failure is possible and in an intense customer-driven workplace such a failure would bring workflow to a halt. Certain activities, for example food in the middle of a cooking cycle, could potentially lead to a dangerous situation in the event of a complete system failure. There are several possible ways to handle failures:

1) A complete spare system on site. In the event of a primary system failure, the backup system would activate and resume workflow management.

2) Headquarters, connected to the system via a network connection, could detect a system breakdown when the system failed to respond to a 15-second watchdog timer implemented as pings from headquarters. Headquarters could immediately call in to temporarily manage workflow and immediately dispatch a human manager and repair crew.

3) At all times, the system could designate a “lead” employee based on seniority or performance. The lead employee would perform a duty somewhat like the passengers in the exit row of a commercial jet aircraft. Passengers in the exit row know that they may be called on to perform an important task. In the event of a system failure, the lead employee would know to attempt to restart the system, call headquarters, and then perform a closing of the facility based on a paper checklist. Preferably, the system is in communication with employees, sensors, and other systems in order to acquire information and give instructions. Information is inputted into the system via communication with humans and automated input devices.

Human input devices include employees communicating with the system, acting as sensors for the system. For example, employees working at the cash register can tell the system the number of customers standing in line at that time. Various means of inputting information can be used, including voice communication, computer terminals, and video communication. Questions with simple answers can currently be answered via oral communication, as these answers can be interpreted by the system using voice analysis programs. Inputting information at a computer terminal allows people to input more complex answers. Video communication can be used for non-verbal information, such as employee identification via facial recognition. Besides acquiring information via these means, the system can also present one or more employees with a situation and allow them to decide how to handle the workflow. For example, an unexpected situation like a leak in the roof might present an interrupt situation to the system. The system would know there is a problem from employee and customer input, but it would not know the nature of the problem immediately. It would ask an employee to go to a terminal and select the problem from a list of known problems. If “leak in roof” is on the list, the system can follow the known procedure. If not, the system would ask employees to solve the problem, and then ask if additional help is needed from headquarters. As another example, the system might be aware of a freezer malfunction due to a rising temperature reading in the freezer. It might ask an employee to try standard solutions, for example to check the door. If that solution did not work, and if the repair service is indicating 8-hour lead-time on repairs, the system might ask a group of employees to elect a leader to find and contact a local ice vendor to get dry ice for the freezer.

The preferred means of communication between an employee and the system is via a two-way aural/vocal personal communication device, e.g. a headset with microphone. The computer addresses the employee via the headset and the employee responds by voice into the microphone. The system limits the questions asked to the employee to ones that can be answered by either a “yes” or “no” or other simple words such as “OK,” “repeat,” “break,” etc. This simplicity of communication commands reduces the difficulty with interpretation and recognition of voice communication. As the voice recognition and natural language interpretation software improve, these can be implemented and allow the system and employees to communicate via more complex language.

Also preferably, the system provides for customer input. A customer feedback interface, such as a computer terminal or an alert button can be positioned such that customer can input complaints, requests, or praise regarding the establishment and its service. For example, an alert button can be positioned near trashcans, bathrooms, napkin dispensers, and the like such that customer can alert the system to a problem in these areas. Also, terminals to receive customer input can be positioned in the establishment or on a website.

In one embodiment of the present invention, the system identifies employees and potentially customers via an identification device, preferably a biometric identification device. For example, employees and customers can be identified via facial recognition. Other means of identification include voice recognition, fingerprint matching, retinal scan, and the like.

The system also advantageously acquires information via automated input devices. These automated input devices include such devices as position trackers located in employee headsets, inventory monitors, cash registers, time clocks, and the like. Other systems can also provide information, for example weather forecast and other environmental information can be retrieved from a weather forecasting system. This information is then integrated into the systems memory and utilized in the management of the establishment.

The system also generates information for communication or output to system users, in particular to employees and management for use in the operation of the establishment. The system outputs this information through a variety of means, including telephone, e-mail, fax, loudspeaker, video screen, headset, and the like to employees, vendors, customers, other systems, and any other entities that need the information.

Thus, the system acquires information, processes it, and outputs it to provide managerial functions to a service operation, as exemplified by the embodiments particularized for a fast food restaurant. The system accumulates experience information over time that makes it able to better manage the establishment, especially under anomalous conditions. This information allows the establishment to run more smoothly and thus better satisfy customers. In addition, this acquired experience remains part of the establishment and cannot be lost due to management personnel changes.

Certain modifications and improvements will occur to those skilled in the art upon a reading of the foregoing description. By way of example, the present system can be used in clerical environments like legal office, call centers, programming shops; with a distributed workforce such as people working at home or salespeople on the road; and in a completely automated workplace. Additional customer counters on doorways, sensors in the driveway or parking lots and the like can be used. Also, multiple systems may be working in a single workplace, each system segregated to handle specific tasks but communicating with one another to manage the entire workplace.

It is also possible for a symbiotic relationship between a human manager and a system according to the present invention to exist to handle more complex management tasks.

Also, the present system may be used directly by consumers. For example, a consumer puts on a headset when entering a store and the system answers questions about item locations and then directs the consumer to the fastest check out line.

It is also possible for the system to manage very sedentary workers, for example security guards, simply by asking them to respond every 5 minutes in order to keep them awake. All modifications and improvements have been deleted herein for the sake of conciseness and readability but are properly within the scope of the following claims.

1. An automated management system for managing a service operation, comprising:
software running on at least one computer and
communications devices for allowing the computer to communicate with human and machine sensors and effectors,
wherein the software includes process control programs and logistics programs for managing at least one service function; and the communications devices include at least one human and at least one automated information input device and at least one information output device connected to the at least one computer.

2. The system of claim 1, wherein the human input and output device is a two-way aural/vocal personal communication device.

3. The system of claim 1, wherein the automated input sensors are local devices such as inventory monitors, cash registers, time clock, position trackers, and the like.

4. The system of claim 1, wherein the automated input sensors are remote devices such as computers and computer networks.

5. The system of claim 1, wherein the automated output devices are selected from the group consisting of fax, telephone, e-mail, video screen, and loudspeaker.

6. The system of claim 1, wherein the human input and output devices are selected from the group consisting of computer terminals and alert buttons.

7. The system of claim 1, wherein the system is in communication with a multiplicity of systems.

8. The system of claim 1, wherein the process control programs include quality control programs.

9. The system of claim 1, wherein the devices and at least one computer are connected via a wireless connection.

10. An automated management system for managing a service operation, comprising:
software running on at least one computer comprising process control programs and logistics programs for managing at least one service function;
and at least one communications device comprising at least one information output device and at least one information input device, the information input device comprising at least one automated input device and at least one human input device, wherein the devices are connected to the at least one computer.

11. The system as in claim 10 wherein the process control programs include quality control programs.

12. The system as in claim 11 wherein the logistics programs include inventory management programs.

13. The system as in claim 11 wherein logistics programs include staffing programs.

14. The device as in claim 10 further including an institutional memory comprising:
pattern recognition program and a pattern storage program.

15. The system as in claim 14 further including a multiplicity of remote systems in communication for information exchange.

16. The system as in claim 15 wherein employee performance information is exchanged.

17. The system as in claim 15 wherein management methods are exchanged.

18. The system as in claim 10 wherein the at least one information output device is selected from the group consisting of a fax machine, a telephone, an electronic messaging system, a video screen, a loudspeaker, and a headphone.

19. The system as in claim 10 wherein the automated input devices are local input devices selected from the group consisting of employee position trackers, environmental parameter meters, inventory movement monitors, cash registers, and time clocks.

20. The system as in claim 10 wherein the at least one automated input device is a remote devices selected from the group consisting of computers, computer systems, and computer networks.

21. The system as in claim 10 wherein the at least one human input device is selected from the group consisting of a two-way aural/vocal personal communication device, an alert device, a computer terminal and a biometric device.

22. The system as in claim 13 wherein the biometric device is based on a biometric selected from the group consisting of face recognition, fingerprint recognition, voice recognition, and retinal scan.

23. An automated management supersystem for managing a multiplicity of service operations, comprising a multiplicity of restaurants managed by an automated management system, comprising:
software running on at least one computer comprising process control programs and logistics programs for managing at least one service function;
and at least one communications device comprising at least one information output device and at least one information input device, the information input device comprising at least one automated input device and at least one human input device, wherein the devices are connected to the at least one computer,
wherein each of the systems are in communication with one another,
thereby providing exchange of information between the individual systems.

24. The system as in claim 23 wherein employee performance information is exchanged.

25. The system as in claim 23 wherein management methods are exchanged.

26. A method for using an automated management system for managing a service operation, the system comprising:
software running on at least one computer and
communications devices for allowing the computer to communicate with human and machine sensors and effectors,
wherein the software includes process control programs and logistics programs for managing at least one service function; and the communications devices include at least one human and at least one automated information input device and at least one information output device connected to the at least one computer, the method comprising the steps of
receiving workflow information from input provided via the communication devices,
monitoring the workflow processes with the software,
determining when a process needs executing,
sending executable process tasks to task list,
prioritizing task list,
instructing employees to execute tasks via the communication devices.
